(19) United States
(12) Patent Application Publication
(10) Pub. No.: US 2017/0050802 A1
(43) Pub. Date: Feb. 23, 2017

(54) INTEGRATED TRASH BAG HANGER

(71) Applicant: Ardavan Yazdi, LOS ANGELES, CA (US)

(72) Inventor: Ardavan Yazdi, LOS ANGELES, CA (US)

(21) Appl. No.: 15/264,576

(22) Filed: Sep. 13, 2016

Related U.S. Application Data
(63) Continuation-in-part of application No. 14/942,991, filed on Nov. 16, 2015, now abandoned.
(60) Provisional application No. 62/080,357, filed on Nov. 16, 2014.

(51) Int. Cl. B65F 1/14; B65F 1/16; B65F 1/06

(52) U.S. Cl. CPC B65F 1/1415; B65F 1/062; B65F 1/163

(57) ABSTRACT

A trash bin hanger comprises a backboard formed from a rigid base member having a front surface and a rigid lip on an upper portion of a rear surface. The rigid lip can hook on a bin with a cavity such that the front and rear surface submerge into the cavity while being supported by the rigid lip when hooked over a rear vertical surface of the bin. A set of rigid rails rigidly attach to the backboard at the front surface of the rigid base member, and extend from the rigid base member towards a front of the bin within the cavity, to support an envelope of trash bags. A trash bag is opened to extend along the set of rails.

### CROSS-REFERENCE TO RELATED PATENT APPLICATIONS

This application is a continuation-in-part of U.S. application Ser. No. 14/942,991, filed on Nov. 15, 2015, by Ardavan Yazdi, which claims the benefit of priority to U.S. application Ser. No. 14/942,991, filed on Nov. 15, 2015, by Ardavan Yazdi, which in turn claims priority to U.S. Provisional Application No. 62/080,357, filed on Nov. 16, 2014, by Ardavan Yazdi, the content of each being hereby incorporated by reference in their entirety.

### FIELD OF THE INVENTION

The invention relates generally to trash containers, and more specifically, to improved trash bags, trash bins and accessories.

### BACKGROUND

Conventional trash bags are designed to be supported by a trash bin. To this end, a single bag is removed from a stack or torn from a roll and then taken to the trash bin for installation. Conventional trash bags are also designed for a single monolithic use with a single cavity. The assumption has been that multiple individual trash bags should be used for multiple requirements. Unfortunately, the conventional approaches can be more expensive and require more effort from installing trash bags.

Another conventional assumption is that trash bags are stored separately from trash bins. A trash bin is typically stored in a position for easy access while trash bags are purchased separately and are stored out of the way because they are accessed with significantly less frequency that the trash bins. As a result, each time a trash bag currently inside of a trash bin fills up, a new bag is retrieved from where ever the trash bags are stored.

It is desirable to overcome these shortcomings.

### SUMMARY

The above-mentioned shortcomings are overcome by an apparatus and method for providing a trash bin hanger to store an inventory of trash bags within a trash bin.

In one embodiment, a backboard of a trash bin hanger is formed from a rigid base member having a front surface and a rigid lip on an upper portion of a rear surface. The rigid lip can hook on a bin with a cavity such that the front and rear surface submerge into the cavity while being supported by the rigid lip when hooked over a rear vertical surface of the bin.

In another embodiment, a set of rigid rails rigidly attach to the backboard at the front surface of the rigid base member, and extend from the rigid base member towards a front of the bin within the cavity. The set of rails can be configured to support an envelope storing garbage bags, for storage within the trash bin. A garbage bag is opened to extend along the set of rails from a first end of the set of rails at the backboard to a second end of the set of rails toward the front of the bin. Garbage bags opens within the cavity of the trash bin. Alternatively, a support section can hold an envelope as new trash bags are dispensed.

Advantageously, new trash bags are conveniently stored and are easily deployed to replace used trash bags.

### BRIEF DESCRIPTION OF THE FIGURES

In the following drawings, like reference numbers are used to refer to like elements. The Figures depict various embodiments for purposes of illustration only. One skilled in the art will readily recognize from the following discussion that other embodiments of the structures and methods illustrated herein may be employed without departing from the described principles.

FIG. 1 is a schematic diagram illustrating trash bags nested to form a trash bin, according to an embodiment.

FIG. 2 is a schematic diagram illustrating trash bags nested for automatic pull-up in a trash bin, according to an embodiment.

FIG. 3 is a schematic diagram illustrating a trash bag accessory for hanging to a trash bin, according to an embodiment.

FIG. 4 is a schematic diagram illustrating a trash bag dispenser for attachment to trash bins, according to one embodiment.

FIG. 5 is a schematic diagram illustrating a trash bag dispenser integrated within a bottom of a trash bin, according to one embodiment.

FIG. 6 is a schematic diagram illustrating a trash bag with separate bins, according to one embodiment.

FIGS. 7 and 8 are schematic diagrams illustrating trash bag dispensers from an interior vertical orientation on a wall of a can, according to one embodiment. The can has railings to which a book of bags is connected. An individual plastic bag can be pulled out from the book of bags and hooked under a lip of the can. The bag breaks apart when lifted out of the can for dispensing.

FIG. 9 is a schematic diagram illustrating a trash bin with a trash bag hanger for dispensing trash bags, according to an embodiment.

FIG. 10 is a schematic diagram illustrating a universal trash bag hanger for dispensing trash bags, according to an embodiment.

FIG. 11 is a schematic diagram illustrating a trash bin with a support section for dispensing trash bags, according to an embodiment.

FIG. 12 is a schematic diagram illustrating a rail grooved envelope, according to an embodiment.

### DETAILED DESCRIPTION

I. Various Embodiments of the Improved Trash Bags, Bins and Accessories

The following section of the description describes details of improved trash bags, bins, and accessories. One of ordinary skill in the art will recognize variations of the examples given, that are within the scope of the disclosure. Advantageously, trash handling is easier for users to change and use.

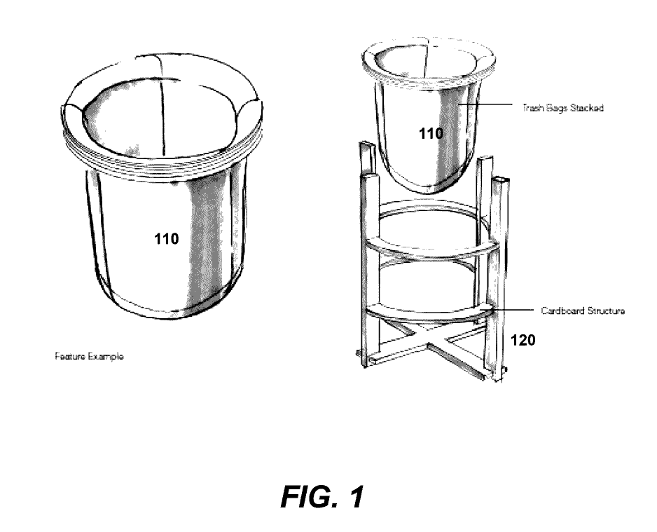

FIG. 1 is a schematic diagram illustrating trash bags nested to form a trash bin 110, according to an embodiment. Multiple trash bags can be manufactured to be consecutively embedded within each other in a self-supporting manner. Each bag is open and expanded without being folded or compressed, in some embodiments. The combination of multiple bags, although individually thin, provides enough support to keep the trash bin in the open and expanded position. In some embodiments, inner bags can be progressively smaller for each bag, every five bags, or any appropriate increment, for easier nesting. At the top, bag shapes can be circular, oval, square or rectangular. At the bottom, bag shapes can be the same shape and size as the top, the same shape and a smaller size, or a different shape.

During manufacture, individual trash bags can be connected by implementation-specific processes. In one example, a small line or several dots of glue is set between each bag. In another example, a flash heat cure melts a small part of each bag which sets to adhere to each successive bag. In still another example, adjacent bags are formed from a single roll and perforations assist a tear that permits bags to be separated. In one case, adjacent bags are connected at a top edge. In a second case, adjacent bags are connected at a bottom, or both top and bottom.

A supporting structure can be provided to prevent the nested bins from tipping over. More support may be provided when only a few bags remain due to deterioration of self-support. The supporting structure can be disposable and made of an inexpensive material such as cardboard. In at least one embodiment, a cardboard structure 120 is implemented to prevent the nested bins from tipping over.

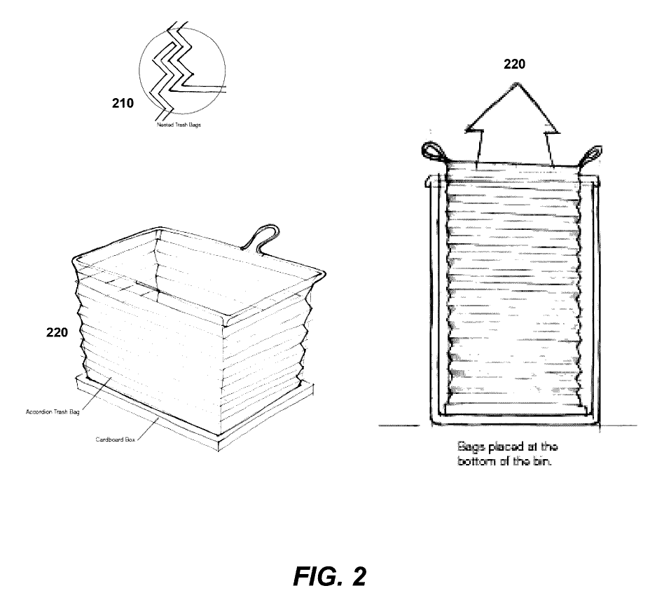

FIG. 2 is a schematic diagram illustrating trash bags 220 nested for automatic pull-up in a trash bin, according to an embodiment. Each trash bag has an accordion shape that compresses to a flat form factor for storage and distribution. As shown in close up 210, a bottom portion of one trash bag interlocks with a top portion of an adjacent trash bag, through the accordion shape of each.

In use, a trash bag is fully opened by expanding the accordion shape and attaching handles at the top of the trash bag to sides of a trash bin. After use, the handles are lifted to pull out the old trash bag and, in turn, pull up a new trash bag. Due to the interlocking of the two adjacent trash bags, the new bag is expanded during the same effort of removing the old bag.

In other embodiments, alternatives to the accordion interlocking are implemented. In still other embodiments, only the interlocking portions are shaped like an accordion.

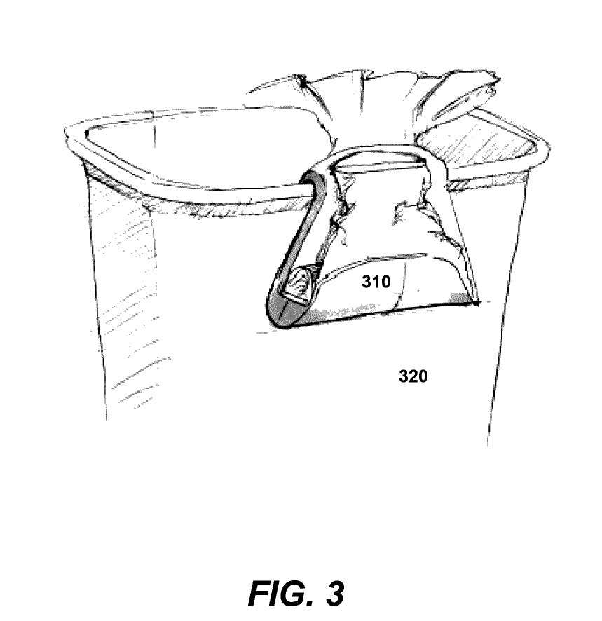

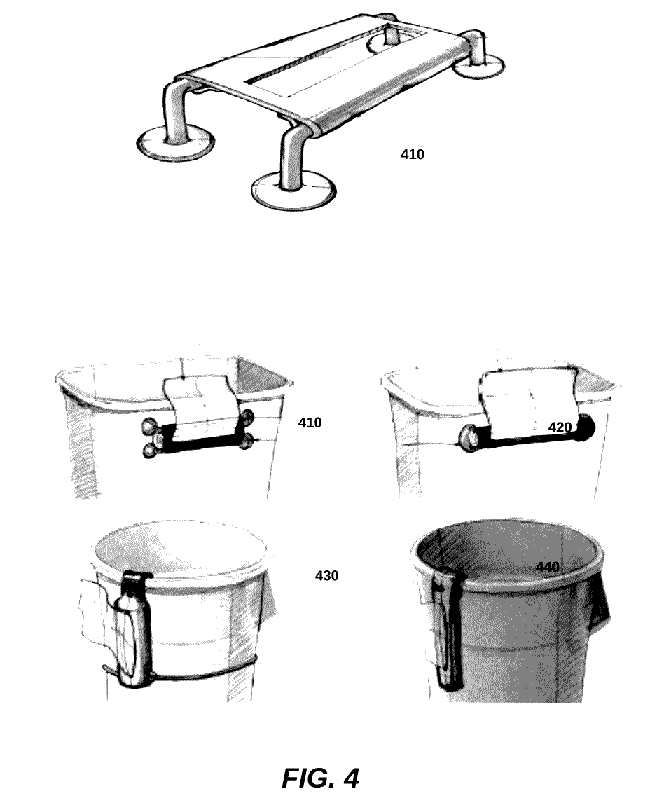

FIG. 3 is a schematic diagram illustrating a trash bag accessory 310 for hanging to a trash bin 320, according to an embodiment. The accessory 310 is adapted to hang on the upper rim of the trash bin 320 for support. Additional embodiments are shown in FIG. 4. Accessory 410 provides four suckers as an alternative mechanism for attachment to a trash bin. Accessory 420 comprises an exterior roll dispenser that allows bag to be peeled off similar to toilet paper on a toilet paper roll. Finally, accessory 430 is attached to the trash bin with a cord while accessory 440 is hangs similar to accessory 310, but in a vertical manner. Many other variations are possible.

A roll of bags are loaded into a cavity and partially advanced to allow a new bag to be dispensed. A user unrolls the new bag and breaks off from the roll for installation. Advantageously, a user does not need to find a roll of bags each time, nor travel away the trash bin 320 in order to retrieve the roll of bags.

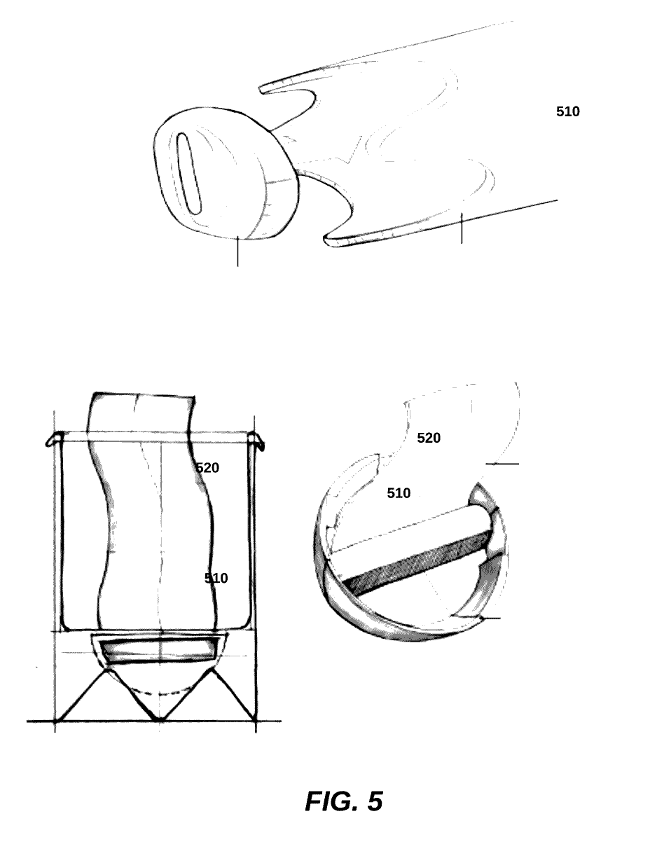

FIG. 5 is a schematic diagram illustrating a trash bag dispenser 510 integrated within a bottom of a trash bin, according to one embodiment. Rather than mounting to a top rim of the trash bin, dispenser 510 mounts to a bottom surface. In one embodiment, the dispenser 510 is integrated into the trash bin with built-in supports, locks and releases. In another embodiment, the dispenser 510 is an after-market product that is manufactured in standard sizes or is capable of being adjusted to different sizes. A roll of trash bags can be loaded from the top, or in an integrated version, be loaded from a side of the bottom by removing a cap.

A new bag 520 is pulled up from the bottom and wrapped around a rim of the trash bin for use. Once full, removal of the old bag can automatically pull up a new bag and be detached upon reaching the rim.

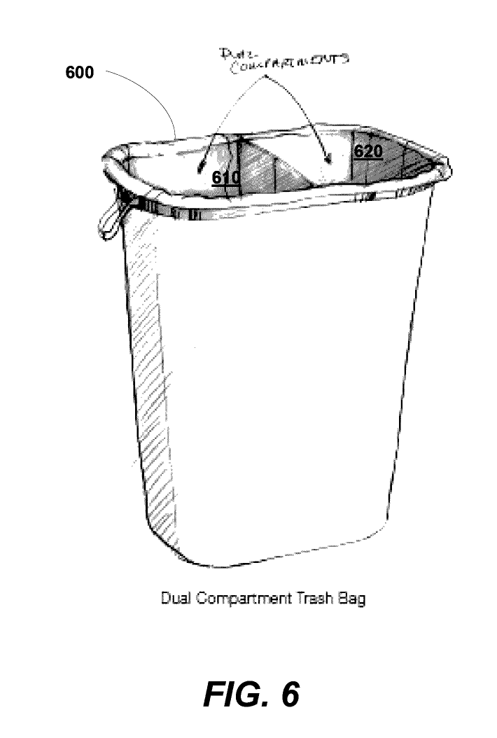

FIG. 6 is a schematic diagram illustrating a trash bag 600 with separate bins 610, 620, according to one embodiment. In the present embodiment, there are two bins side-by-side of uniform size in a lengthwise direction. Other embodiments can have three or more bins. Still other embodiments can have varying bin sizes.

In one embodiment, the bins can be separately detached and carried away. Both bins may have to be detached before a new pair can be fed through or the two bins can be independently fed. For the consumer, different bins can have different uses, such as one bin for compost and one bin for recycling, and the bags can be separately carried to a street trash can.

New bags can be dispensed as described herein, for example, bottom fed or top fed.

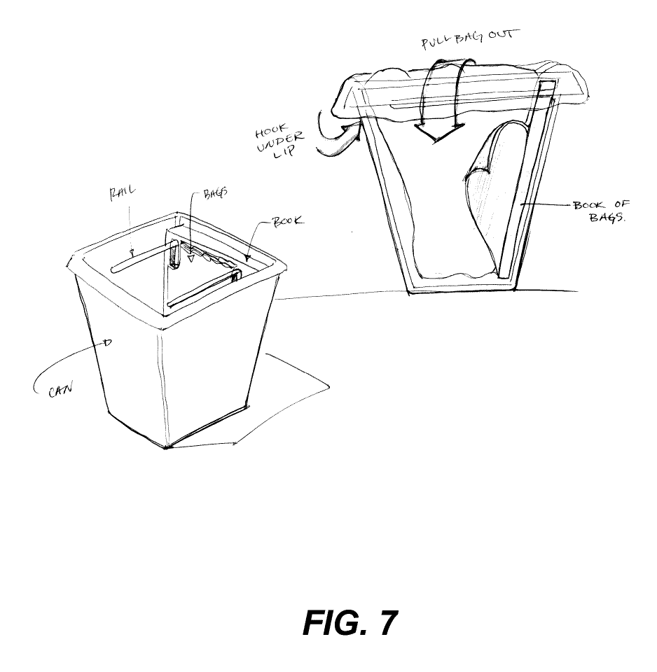

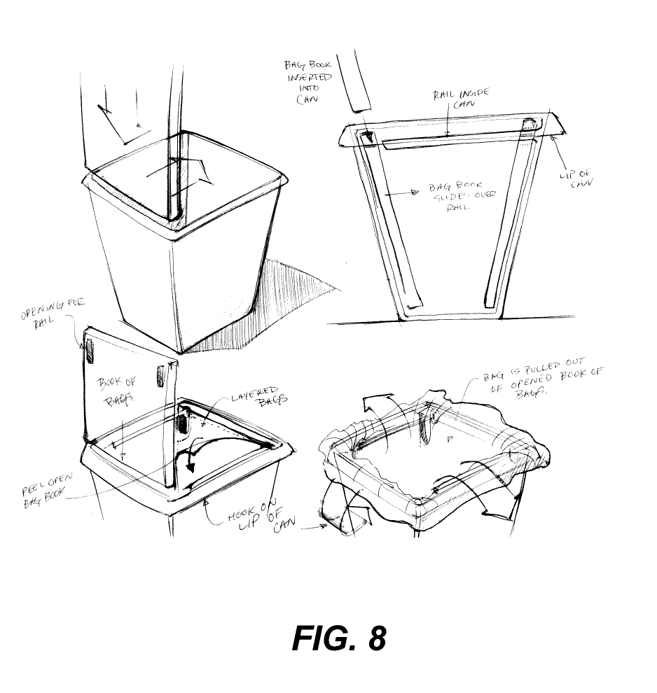

FIGS. 7 and 8 are schematic diagram illustrating trash bag dispensers from an interior vertical orientation on a wall of a can, according to one embodiment. The can has railings to which a book of bags is connected. An individual plastic bag can be pulled out from the book of bags and hooked under a lip of the can. The bag breaks apart when lifted out of the can for dispensing.

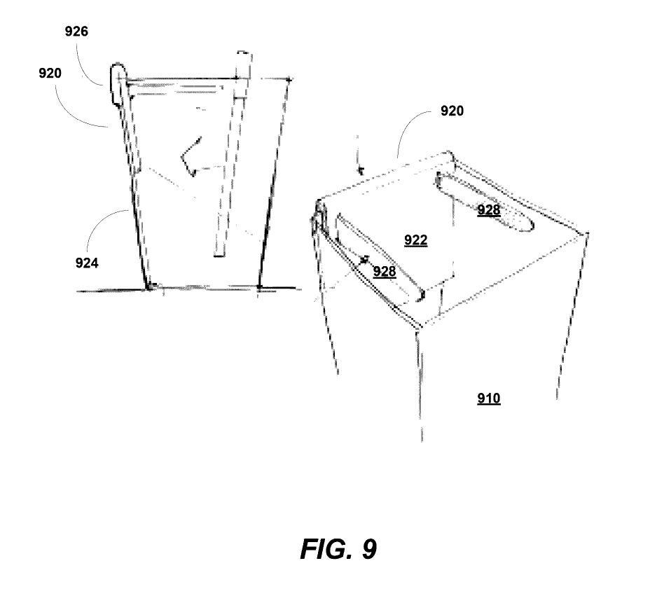

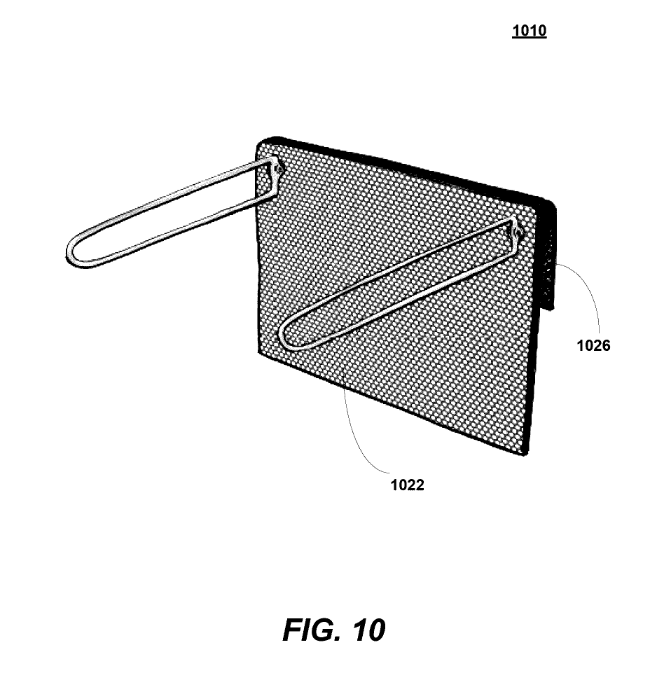

FIGS. 9 and 10 are views of a schematic diagram illustrating a trash bin 910 with a trash bag hanger 920 for dispensing trash bags, according to an embodiment.

The trash bin 910 can be square-shaped or rectangular-shaped, in some implementations. A straight-edge wall along the rear cavity provides support for a straight-edge trash bag hanger 920. In some embodiments, the trash bin 910 was not manufactured for compatibility with the trash bag hanger 920, so the trash bag hanger 920 is sized to fit over various different sizes of trash bins. In other embodiments, the trash bin 910 is manufactured to accommodate the trash bag hanger 920 in an integrated manner.

The trash bag hanger 920 comprises a hook and rail backboard, in one embodiment. A first member 922 has a surface that engages a rear wall 924 of the trash bin 910 for horizontal support, when installed. A lip 926 hooks over the trash bin 920 for vertical support. In more detail, when a new trash bag is pulled out from an envelope, a generally horizontal force is transferred by the first member 922 to the rear wall of the trash bin 910. Additionally, the weight of the trash bag hanger 920 is supported by the lip 926.

A set of rails 928 extends from the first member 922 of the hook and rail backboard outwards. The rails can be composed of a rigid material such as metal or plastic. When installed, the set of rails extends towards a front wall of the trash bin. A length of the set of rails 928 corresponds to a width of the trash bin because the set of rails 928 fit within a cavity of the trash bin. In some implementations, the set of rails have adjustable lengths so that the set of rails can be extended or contracted to fit different sized cavities. Alternatively, the set of rails are detachable from the hook and rail backboard and can be replaced with a different set of rails having a different size.

FIG. 10 shows a trash bag hanger 1010 separate from any specific trash bin. The trash bag hanger 1010 can fit various sized trash bins, such a smaller office of bathroom trash bin or a larger kitchen or outdoor sized bin. A small gap between the first member 1022 and the lip 1026 can be sized to cover a range of various trash bins. The variation is in width of the rear wall 1010 of different trash bins a well a cavity size.

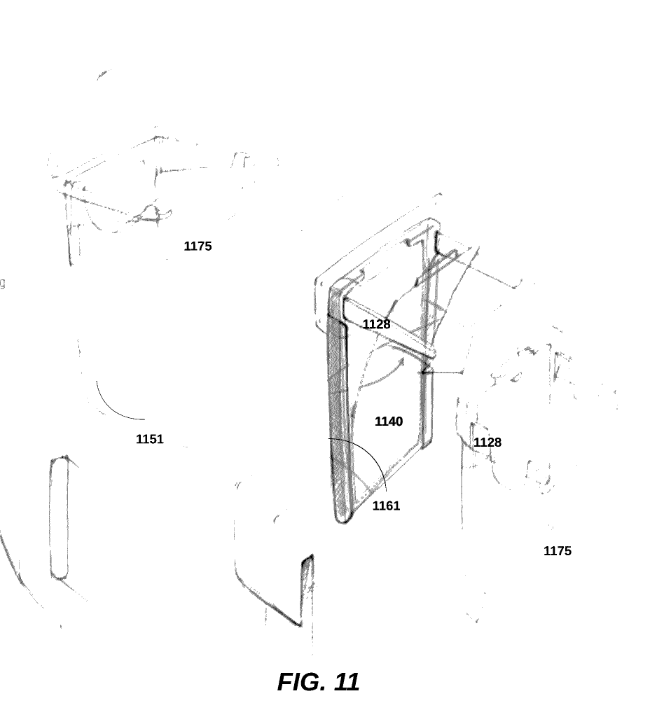

FIG. 11 shows an envelope 1140 of trash bags (or book of trash bags) engaged with and slid back on to a set of rails 1128. A perforated lid can be pulled off and a trash bag 1175 is pulled out to extend along the set of rails 1128. There can be hooks to engage trash bag handles in maintaining an open position. When the trash bag 1175 is removed because full or otherwise, a new trash bag slides out and replaces the used one. When the envelope 1140 is devoid of any more trash bags, the empty cardboard can be removed and replaced with a new envelope filled with trash bags.

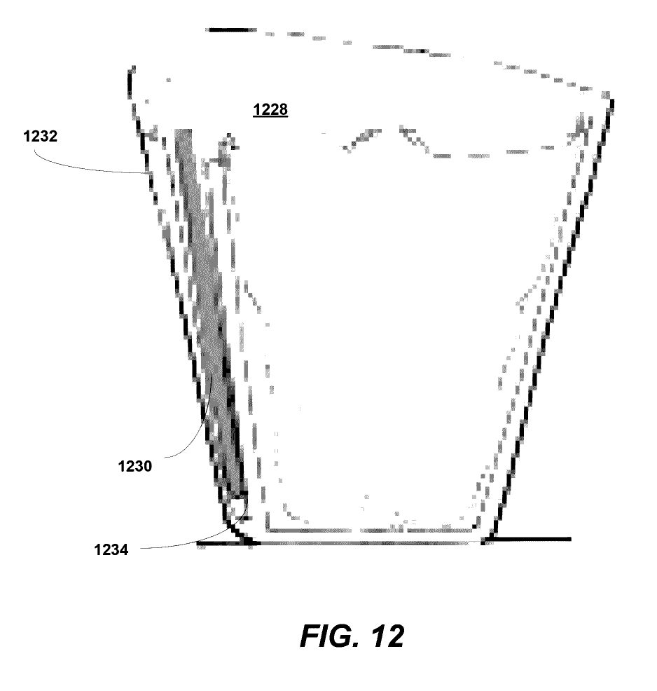

In certain embodiments, apertures 1151 form circular or oval-shaped holes for sliding over rails. In other embodiments, apertures 1161 form grooves on an envelope that are configured to fit over a set of rails rather than fit through. This allows the envelope to slide on top of the rails rather than slide over the rails, as discussed in the embodiment of FIG. 12.

FIG. 12 is a schematic diagram illustrating a trash bin with a support section 1230 for dispensing trash bags, according to an embodiment. The support section 1230 can be located in a rear sub-volume of a trash bin cavity. This allows trash bags to be opened towards a front of the trash bin. However, some embodiments can be configured to open bags from the front or from either side of the trash bin as well.

Structurally, the support section 1230 preferably shares an exterior wall 1232 of the trash bin, and has an additional support wall 1234 generally parallel with the exterior wall. The support section 1230 can be sized to fit envelopes snuggly or to allow several envelopes to be inserted. When a new trash bag is pulled over a set of rails 1228, the support wall holds the envelope in place. An envelope within the support section 1230 can include a horizontal slit near a top so that trash bags can be maneuvered into position over the support wall 1234. Consequentially, some embodiments have the support wall 1234 that is slightly shorter than the exterior wall 1232.

A foot activated lid, in one embodiment, is opened with foot pressure to expose the support section 1230. Once exposed, an envelope can be dropped in, or a new trash bag can be opened. Many other variations and alternative implementations are possible.

II. Generalities of the Improved Trash Bags, Bins and Accessories

Improved trash bags, bins, and accessories are described herein. The term trash bag used herein can also refer to a bin bag, bin liner, or garbage bag. Trash bags are used to collect disposables which can be compost, recyclables, of the like. Many different materials can be used for manufacture, such as plastic, rubber, paper, or other synthetic materials, or other environmental friendly materials. Trash bins and bags can be of any color, such as black or white, and have additional features such as handles, drawstrings or aesthetic designs.

The embodiments discussed herein are applicable to residential uses of, for example, 5 or 10 gallon sizes, or even smaller containers. The embodiments are also applicable to commercial or industrial uses, for example, 55 gallons or larger. The trash bins used for the new trash bags and accessories described can be small plastic ones, or large metal barrels.

As will be understood by those familiar with the art, the subject matter described herein may be embodied in other specific forms without departing from the spirit or essential characteristics thereof. Likewise, the particular naming and division of the portions, modules, agents, managers, components, functions, procedures, actions, layers, features, attributes, methodologies, data structures and other aspects are not mandatory or significant, and the mechanisms that implement the subject matter or its features may have different names, divisions and/or formats. The foregoing description, for purpose of explanation, has been described with reference to specific embodiments. However, the illustrative discussions above are not intended to be exhaustive or limiting to the precise forms disclosed. Many modifications and variations are possible in view of the above teachings. The embodiments were chosen and described in order to best explain relevant principles and their practical applications, to thereby enable others skilled in the art to best utilize various embodiments with or without various modifications as may be suited to the particular use contemplated.

I claim:

1. A universal trash bag hanger for various trash bins, comprising:
a backboard formed from a rigid base member having a front surface and a rigid lip on an upper portion of a rear surface,
wherein the rigid lip is configured to hook on a bin with a cavity such that the front and rear surface submerge into the cavity while being supported by the rigid lip when hooked over a rear vertical surface of the bin; and
a set of rigid rails rigidly attached to the backboard at the front surface of the rigid base member, and extending from the rigid base member towards a front of the bin within the cavity, the set of rails configured to support an envelope storing garbage bags,
wherein a garbage bag is opened to extend along the set of rails from a first end of the set of rails at the backboard to a second end of the set of rails toward the front of the bin, wherein the garbage bag opens within the cavity of the trash bin.

2. The universal trash bag hanger of claim 1, wherein spacing between the backboard and the rigid lip is sized to fit any of the various trash bins in addition to the bin.

3. The universal trash bag hanger of claim 2, wherein the various trash bins include at least one 5-gallon trash bin and at least one 10-gallon trash bin.

4. The universal trash bag hanger of claim 1, wherein the blackboard and the set of rigid rails are composed of at least one of: metal, plastic and rubber.

5. The universal trash bag hanger of claim 1, wherein the backboard is oriented generally vertical and the set of rails are oriented generally horizontal.

6. The universal trash bag hanger of claim 1, wherein the envelope comprises apertures sized and spaced corresponding to installation by sliding the envelope along the set of rails.

7. The universal trash bag hanger of claim 1, wherein the trash bin is generally square-shaped or generally rectangular-shaped.

8. A universal trash bag hanger for various trash bins, comprising:
a section within a cavity of a trash bin to support an envelope of trash bags in a generally vertical orientation;
a set of rigid rails within the cavity rigidly attached to a rear surface of the bin, and extending from the rear surface towards a front surface of the bin within the cavity, the set of rails configured to support a garbage bag opened to extend along the set of rails from a first end of the set of rails at the rear surface to a second end of the set of rails toward the front surface of the bin, wherein the garbage bag opens within the cavity of the trash bin.

9. The universal trash bag hanger of claim 8, wherein the section is formed by the rear surface of the trash bin and a support surface oriented vertically, a width of the section being smaller than a width of the cavity.

10. The universal trash bag hanger of claim 8, wherein the support surface holds the envelope in place as the trash big is extended along the rails.

11. The universal trash bag hanger of claim 8, wherein the trash bin comprises a lid, and wherein the section can be accessed when the lid is removed.

12. The universal trash bag hanger of claim 8, wherein the envelope comprises apertures sized and spaced corresponding to installation to the section by dropping the envelope vertically into the section as guided by the set of rails.
